(19) United States
(12) Patent Application Publication
(10) Pub. No.: US 2026/0241521 A1
(43) Pub. Date: Aug. 20, 2026

(54) DEVICE AND METHOD FOR REMOVING A LOCK-UP PIN OF A TENSIONER FOR A BELT DRIVE

(71) Applicant: MUVIQ S.R.L., Ivrea (IT)

(72) Inventors: Flavio Alejandro ROCA FUMAGALLI, CHIETI (IT); Giuseppe AQUILINO, CHIETI (IT)

(73) Assignee: MUVIQ S.R.L., Ivrea (IT)

(21) Appl. No.: 18/870,007

(22) PCT Filed: Apr. 24, 2023
(86) PCT No.: PCT/IB2023/054183

§ 371 Date: Nov. 27, 2024

(30) Foreign Application Priority Data
Jun. 1, 2022 (IT) 102022000011642

(51) Int. Cl. B25B 27/04; F16H 7/08

(52) U.S. Cl. CPC B25B 27/04; F16H 7/08; F16H 2007/0842

(57) ABSTRACT

Device for removing a lock-up pin of a tensioner having a main body provided with a key couplable to a loading element integral with an arm of the tensioner, a lever rigidly coupled to the main body, a sliding element prismatically coupled to the main body and movable with respect to it along a first axis parallel to an axis of the lock-up pin when the key is coupled to the loading element. A magnet carried by the sliding element is configured to interact with the lock-up pin of the tensioner. The sliding element is movable between a rearward rest position and a forward position of coupling with the lock-up pin. An elastic member exerts an elastic force on the sliding element parallel to the direction of relative motion between the main body and the sliding element to return the sliding element from the forward position to the rest position.

### CROSS-REFERENCE TO RELATED APPLICATIONS

This Patent Application claims priority from Italian Patent Application No. 102022000011642 filed on Jun. 1, 2022, the entire disclosure of which is incorporated herein by reference.

### TECHNICAL FIELD

The present invention relates to a device and method for removing a lock-up pin of a tensioner for a belt drive.

### BACKGROUND ART

As is known, a tensioner for a belt of a transmission comprises a base, an arm hinged to the base, a pulley carried by the arm and rotatable with respect to it, and a spring exerting on the arm a torque configured to maintain the pulley in contact with the belt. Generally, the tensioner further comprises a lock-up pin configured to lock the arm with respect to the base in an installation position.

Conveniently, the tensioner is provided in the installation position, i.e. with the lock-up pin inserted so as to lock the arm with respect to the base. This facilitates the installation of the belt and of the tensioner, in particular the positioning and the fixing of the base, but makes it necessary to remove the lock-up pin so as to make the tensioner operational.

Since the lock-up pin is subject to cutting forces exerted by the spring on the arm, its removal is possible only in an equilibrium condition where such forces are manually balanced by an operator who acts with a key on a loading element integral with the arm. Such action is carried out with one hand only because the other hand is engaged in manually extracting the lock-up pin. The manual effort required is thus very high.

A purpose of the present invention is to provide a device which can overcome the above problems.

### DISCLOSURE OF THE INVENTION

The aforementioned purpose is achieved by a device as claimed in claim 1.

The present invention further relates to a method as claimed in claim 10.

### BRIEF DESCRIPTION OF THE DRAWINGS

For a better understanding of the present invention, a preferred embodiment is described below, by way of non-limiting example and with reference to the accompanying drawings, wherein:

FIG. 1 is a front view of a device according to the present invention;

FIG. 2 is a rear view of the device of FIG. 1;

FIG. 3 is a side view of the device of FIG. 1;

FIG. 4 is a cross-sectional view along line IV-IV of FIG. 1;

FIG. 5 is a cross-sectional view along line V-V of FIG. 3;

FIG. 6 is a partial cross-sectional view along line VI-VI of FIG. 1 in enlarged scale;

FIG. 7 is a partial side view, on an opposite side of FIG. 3, and in enlarged scale of the device of FIG. 1 in a different operational position; and

FIG. 8 is a partial exploded view of the device of FIG. 1.

### DETAILED DESCRIPTION OF THE INVENTION

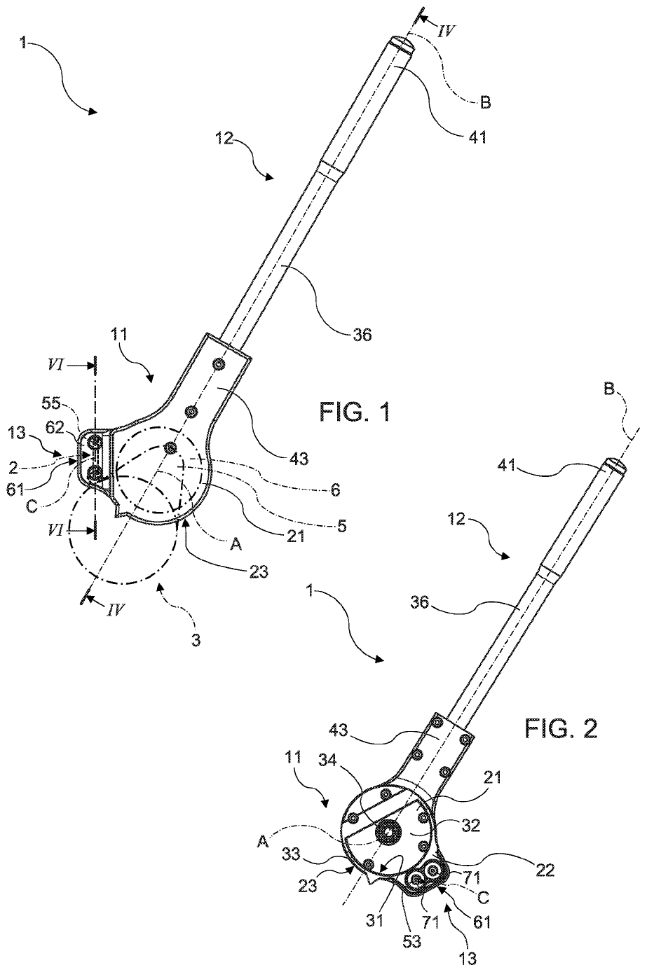

With reference to FIG. 1, there is indicated by 1 a device for removing a lock-up pin 2 of a tensioner 3 according to the present invention.

In particular, the tensioner 3 is of known type and comprises a base 4, an arm 5 hinged to the base 4, and a pulley 6 carried by the arm 5 and rotatable with respect to it. The tensioner 3 further comprises as spring (not illustrated) exerting on the arm 5 a torque configured to cause a rotation of the arm 5 with respect to the base 4 in a direction such as to maintain, in use, the pulley 6 in contact with a belt (not illustrated) of a transmission, for example an accessory transmission of an internal combustion engine. The lock-up pin 2 is configured to lock the arm 5 with respect to the base 4 in an installation position, and must be removed so as to make the tensioner 3 operational and to enable the rotation of the arm 5 under the action of the spring.

The device 1 comprises a main body 11, a lever 12 rigidly coupled to the main body 11, and a sliding element 13 prismatically coupled to the main body 11.

The main body 11 comprises a coupling portion 21, substantially shaped as a cylinder of axis A, and a guiding portion 22 extending along a lateral outer surface 23 of the coupling portion 21 and configured to guide the sliding element 13.

The coupling portion 21 (FIG. 2) of the main body 11 is configured to couple to the tensioner 3. In particular, the coupling portion 21 has a substantially cylindrical seat 31, defined by a substantially circular portion 32 of axis A and by a circumferential edge 33 extending axially from the lateral outer surface 23. The coupling portion 21 is provided with a key 34 of axis A, arranged in the portion 32, couplable to a loading element 35 integral with an arm 5 of the tensioner 3.

In particular, the loading element 35 (FIG. 4) is a prismatic end of a pin of the pulley 6 of the tensioner 3. Therefore, the seat 31 is configured to at least partially accommodate the pulley 6, and the key 34, of “female” type, is configured to prismatically cooperate with the loading element 35. Conveniently, the key 34 is interchangeable and can be chosen based on the prismatic end of the pin so as to couple thereto.

The lever 12 comprises a rod 36 extending along an axis B, orthogonal to the axis A, and rigidly coupled to the coupling portion 21.

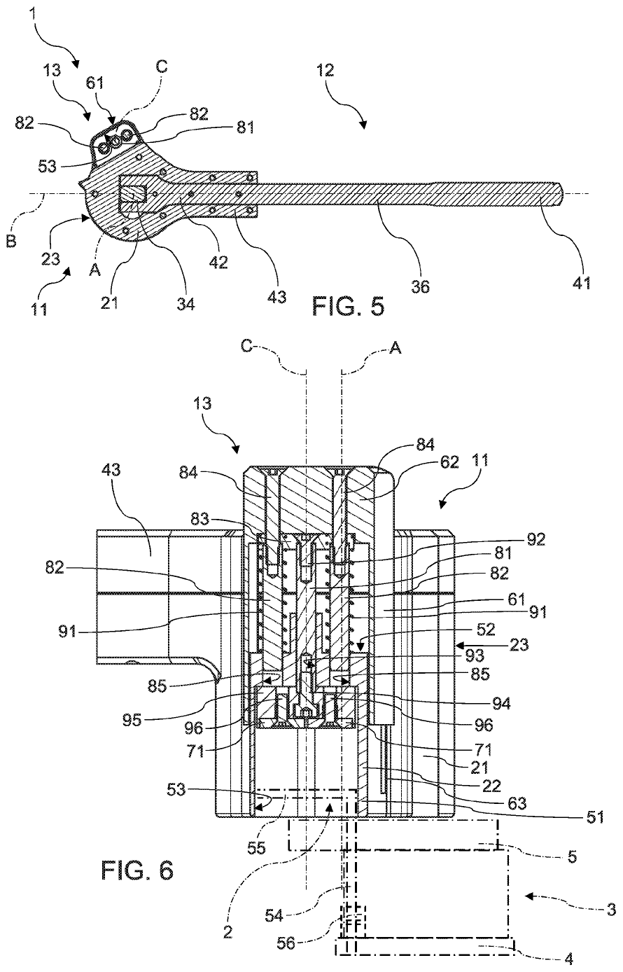

The rod 36 (FIGS. 4 and 5) comprises a first end 41 which is free and constitutes a handle of the device 1, and a second end 42 which is inserted inside the main body 11 and carries the key 34. Conveniently, the main body 11 has a connecting portion 43, substantially tubular, which extends along the axis B from the coupling portion 21 and envelops a section of the rod 36 close to the second end 42.

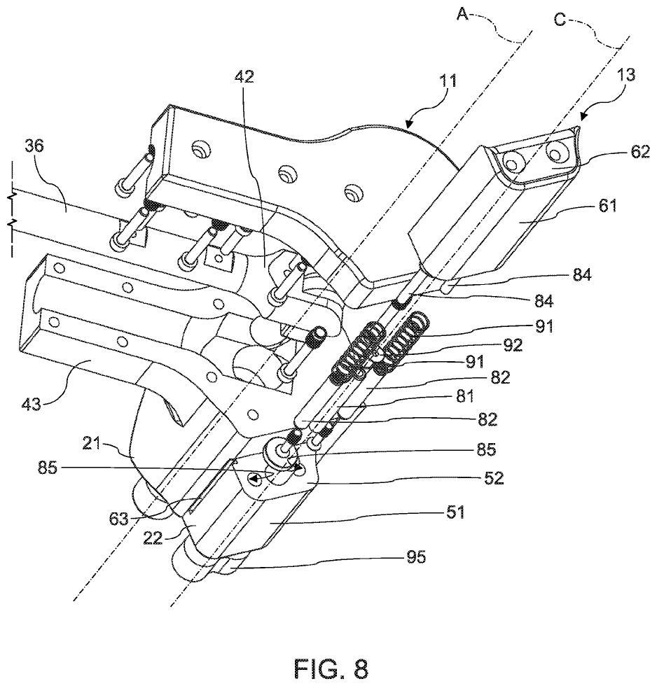

The guiding portion 22 of the main body 11 (FIG. 8) is substantially shaped as a prism with a trapezoidal base, which extends along an axis C, parallel to the axis A, and is coupled to the coupling portion 21 along a lateral face of its own corresponding to the larger base of the trapezium. The guiding portion 22 (FIG. 6) is hollow and has a lateral wall 51 and a base wall 52, orthogonal to the axis C, delimiting, as a whole, a cavity 53 which is open on the side of the edge 33 of the coupling portion 21 and configured to at least partially accommodate the lock-up pin 2.

In particular, the lock-up pin 2 is made of ferromagnetic material and is typically L-shaped, with a long section 54 defining an axis of the lock-up pin 2 and a short section 55 orthogonal thereto. The long section 54 is configured to lock the arm 5 with respect to the base 4 of the tensioner 3 in the installation position, engaging respective holes (not illustrated) obtained respectively in a radial appendix 56 of the arm 5 and in the base 4, and the short section 55 is arranged on the opposite side with respect to the base 4 of the tensioner 3.

The cavity 53 of the guiding portion 22 is sized to allow the entry of the lock-up pin 2 along its own axis, arranged parallel to the axis C, so that the short section 55 is completely accommodated in the cavity 53 and the long section 54 is at least partially accommodated in the cavity 53.

The sliding element 13 is shaped to at least partially envelop the guiding portion 22. In particular, the sliding element 13 is substantially a prism with a trapezoidal base, shaped similarly to the guiding portion 22 and having a cavity sized to accommodate the guiding portion 22. In particular, the sliding element 13 comprises a lateral wall 61, shaped to envelop and slide along the lateral wall 51 of the guiding portion 22, and a base portion 62 arranged on the opposite side with respect to the edge 33 and extending from the lateral wall 61 towards the coupling portion 21.

Preferably, the axial length of the lateral wall 61 is substantially equal to the axial length of the coupling portion 21.

The lateral wall 61 of the sliding element 13 has, along its own lateral edges adjacent to the main body 11, respective axial projections slidable in respective grooves 63 present on the guiding portion 22. Therefore, the sliding element 13 behaves like a slide sliding on the guiding portion 22.

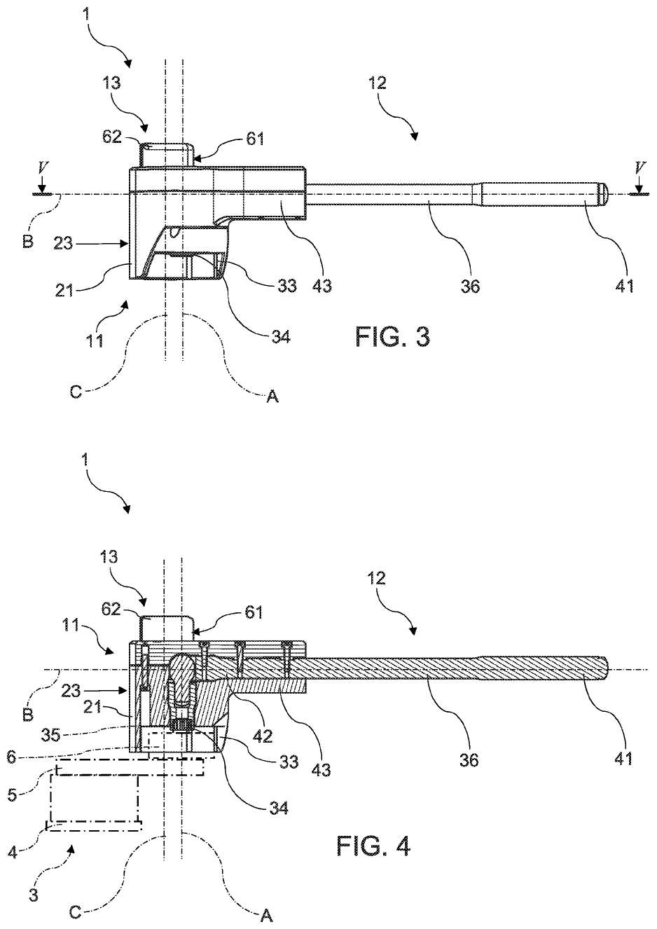

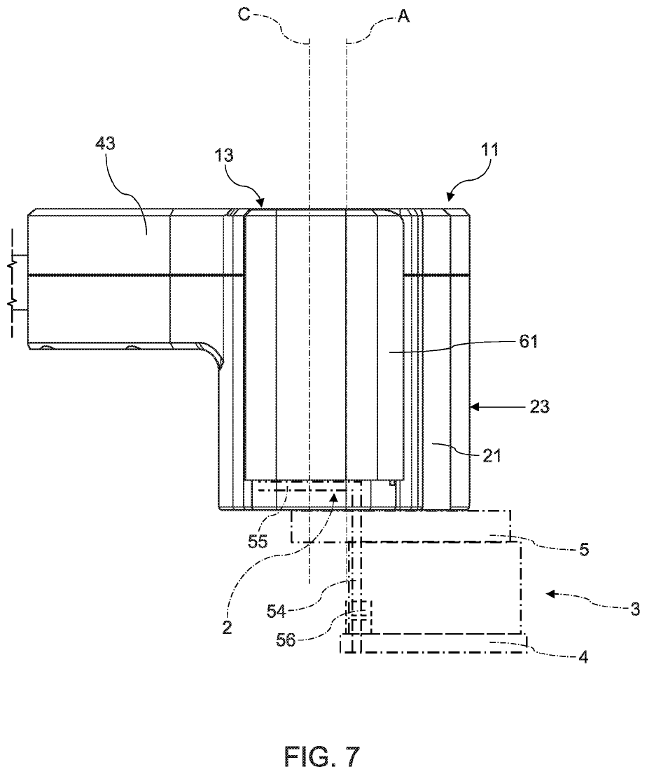

The sliding element 13 is movable between a rearward rest position (FIGS. 3, 4 and 6) and a forward position of coupling (FIG. 7) wherein it interacts with the lock-up pin 2.

The device 1 (FIG. 6) further comprises two magnets 71 carried by the sliding element 13 and configured to interact with the lock-up pin 2 of the tensioner 3.

In particular, the sliding element 13 internally comprises a cylindrical central element 81 of axis C and two cylindrical lateral elements 82 having axes parallel to the axis C, equidistant from it and arranged along a plane which contains it.

The cylindrical lateral elements 82 have respective first ends accommodated in a plate 83 arranged in contact with the base portion 62 and are fixed to the latter via screws 84 passing through the base portion 62 and the plate 83. Second ends of the cylindrical lateral elements 82 are accommodated in a sliding manner in respective holes 85 of the base wall 52 of the guiding portion 22. Between the plate 83 and the base wall 52 of the guiding portion 22 respective compression springs 91 are mounted pre-compressed, coaxial to the cylindrical lateral elements 82. Therefore, the springs 91 exert on the sliding element 13 an elastic force configured to return the sliding element 13 from the forward position to the rest position.

The cylindrical central element 81 has a first end fixed to the plate 83 via a screw 92, has a greater length with respect to the cylindrical lateral elements 82 and is axially slidable through a through-hole 93 of axis C of the guiding portion 22. A second end of the cylindrical central element 81 is fixed, via a screw 94, to a supporting block 95 accommodated in a sliding manner in the cavity 53 of the guiding portion 22. The supporting block 95 carries the magnets 71, fixed thereto via screws 96 and arranged on opposite sides with respect to the axis C so as to magnetically interact with the short section 55 of the lock-up pin 2.

In use, the device 1 allows removing the lock-up pin 2 of the tensioner 3.

In particular, the method for removing the lock-up pin 2 of the tensioner 3 via the device 1 comprises several steps, described in detail hereinafter starting from a configuration where the tensioner 3 is in the installation position, the lock-up pin 2 locks the arm 5 with respect to the base 4, and the belt is installed.

Initially, the device 1 is coupled to the tensioner 3 so that the key 34 engages the loading element 35.

In particular, the key 34 is prismatically coupled to the prismatic end of the pin of the pulley 6 of the tensioner 3 so that the axis A coincides with the axis of the pin. Therefore, the seat 31 of the coupling portion 21 at least partially accommodates the pulley 6 of the tensioner 3, and the cavity 53 of the guiding portion 22 at least partially accommodates the lock-up pin 2, and in particular the short section 55 thereof.

Subsequently, the sliding element 13 is displaced from the rearward rest position to the forward position of coupling with the lock-up pin 2, against the action of the springs 91, so as to magnetically couple the magnets 71 to the lock-up pin 2.

Since the sliding element 13 is movable with respect to the main body 11 along the axis C, parallel to the axis of the lock-up pin 2 when the key 34 is coupled to the loading element 35, the magnets 71 carried by the sliding element 13 contact the short section 55 of the lock-up pin 2.

When the sliding element 13 is in the forward position of coupling, the springs 91 exert restoring forces which tend to return it in the rearward rest position, thus removing the lock-up pin 2 from the tensioner 3. However, the long section 54 of the lock-up pin 2 is subject to cutting forces caused by the spring of the tensioner 3, which exerts on the arm 5 a torque configured to cause a rotation of the arm 5 with respect to the base 4 in a first direction of rotation. Therefore, the lock-up pin 2 still remains in the tensioner 3 and the sliding element 13 still remains in the forward position of coupling.

Subsequently, on the lever 12 a torque is exerted opposite to the first direction of rotation so as to balance the torque exerted by the spring of the tensioner 3 on the arm 5 and thus annul the cutting forces which act on the long section 54 of the lock-up pin 2, thus releasing the lock-up pin 2. Therefore, the lock-up pin 2 is automatically removed from the base 4, and possibly also from the arm 5, since the sliding element 13 returns in the rearward rest position under the restoring action of the springs 91.

Subsequently, it is possible to guide the rotation of the device 1 under the action of the spring of the tensioner 3 to a position where the pulley 6 cooperates with the belt and the force exerted by the contact between the belt and the pulley 6 balances the torque exerted by the spring of the tensioner 3 on the arm 5.

At this point, it is possible to remove the device 1 from the tensioner 3, by decoupling the key 34 from the loading element 35, since the resultant of the cutting forces on the loading element 35 of the tensioner 3 is null. Therefore, the key 34 can be easily decoupled from the loading element 35. The lock-up pin 2 remains magnetically coupled to the device 1 thanks to the magnetic interaction between the lock-up pin 2 and the magnets 71.

Finally, it is possible to manually extract the lock-up pin 2 from the device 1, decoupling it from the magnets 71.

Upon examination of the characteristics of the device 1, the advantages of the present invention are evident.

In particular, the device 1 allows removing the lock-up pin 2 in a simple and quick manner, exerting a reduced manual effort. Indeed, since the extraction of the pin is carried out automatically by the springs 91, the operator has both hands free for exerting on the lever 12 a torque which is sufficient for balancing the torque of the spring of the tensioner 3.

Since the key 34 is interchangeable, it is possible to use the device 1 on different tensioners simply by choosing a key 34 corresponding to the loading element 35 of the tensioner 3.

Finally, it is clear that modifications and variations can be made to the device 1 without going beyond the scope of protection defined by the claims.

For example, the structure of the main body 11, the lever 12 and the sliding element 13 can be different from that described.

The key 34 can be of “male” type instead of “female” type, if the loading element 35 of the tensioner 3 is a key of “female” type.

1. Device for removing a lock-up pin of a tensioner, comprising:
a main body provided with a key couplable to a loading element integral with an arm of the tensioner,
a lever rigidly coupled to the main body,
a sliding element prismatically coupled to the main body and movable with respect to it along a first axis (C) parallel to an axis of the lock-up pin when the key is coupled to the loading element,
at least one magnet carried by the sliding element and configured to interact with the lock-up pin of the tensioner,
wherein the sliding element is movable between a rearward rest position and a forward position of coupling with the lock-up pin, and
an elastic member exerting an elastic force on the sliding element parallel to a direction of relative motion between the main body and the sliding element to return the sliding element from the forward position to the rest position.

2. The device as claimed in claim 1, wherein the main body comprises a coupling portion provided with said key and a guiding portion configured to guide the sliding element.

3. The device as claimed in claim 2, wherein the coupling portion has a seat configured to at least partially accommodate a pulley of the tensioner, said key being housed in the seat and configured to cooperate with a prismatic end of a pin of the pulley defining the loading element.

4. The device as claimed in claim 2, wherein the guiding portion has a cavity configured to at least partially accommodate the lock-up pin.

5. The device as claimed in claim 2, wherein the guiding portion extends along an outer surface of the coupling portion and the sliding element is shaped to at least partially envelop the guiding portion.

6. The device as claimed in claim 1, wherein the lever comprises a rod orthogonal to the first axis (C).

7. The device as claimed in claim 2, wherein the elastic means are operatively interposed between the guiding portion and the sliding element.

8. The device as claimed in claim 7, wherein the elastic means comprise at least one compression spring having an axis parallel to the first axis (C) and wherein the at least one compression spring has a maximum extension in the forward position of the sliding element and a minimum extension in the rearward position of the sliding element.

9. The device as claimed in claim 1, wherein the key is interchangeable.

10. Method for removing a lock-up pin of a tensioner via a device as claimed in claim 1, the tensioner comprising a base, an arm hinged to the base, a spring exerting on the arm a torque configured to cause a rotation of the arm with respect to the base in a first direction of rotation, a lock-up pin configured to lock the arm with respect to the base in an installation position, a pulley carried by the arm and rotatable with respect to it about a second axis, and a loading element integral with an arm of the tensioner, the pulley being configured to cooperate with a belt of a transmission, the method comprising:
coupling the device to the tensioner so that the key engages the loading element;
displacing the sliding element from the rearward rest position to the forward position of coupling with the lock-up pin against the action of the elastic means, to magnetically couple the at least one magnet to the lock-up pin; and
exerting on the lever a torque opposite to the first direction of rotation so as to balance the torque exerted by the spring of the tensioner on the arm, thus releasing the lock-up pin at least from the base via the displacement of the sliding element from the forward position of coupling to the rearward rest position via the elastic means.

11. The method as claimed in claim 10, comprising:
guiding the rotation of the device under the action of the spring of the tensioner to a position where the pulley cooperates with the belt and the force exerted by the contact between the belt and the pulley balances the torque exerted by the spring of the tensioner on the arm;
removing the device from the tensioner by decoupling the key from the loading element; and
removing the lock-up pin from the device.
